(19) United States
(12) Patent Application Publication
(10) Pub. No.: US 2015/0363051 A1
(43) Pub. Date: Dec. 17, 2015

(54) RADIAL DISPLAY GENERATION AND INTERACTIVE SYSTEM

(71) Applicant: Google Inc., Mountain View, CA (US)

(72) Inventors: Jin Yao, San Jose, CA (US); Igor Arkadievich Ferst, San Mateo, CA (US); Simon Rosen, Loughton (GB); John Chih Chang Huang, Sunnyvale, CA (US)

(21) Appl. No.: 14/670,640

(22) Filed: Mar. 27, 2015

(30) Foreign Application Priority Data
Jun. 15, 2014 (IL) 233139

(51) Int. Cl. G06F 3/0482; G06F 17/30; G06F 3/0484; H04L 29/08

(52) U.S. Cl. CPC G06F 3/0482; H04L 67/02; G06F 17/30327; G06F 17/30572; G06F 3/04842

(57) ABSTRACT

A visual display and interactive system for displaying data describing sequences and patterns which contain entities (e.g., search terms or keywords from web searches) may be provided to analyze the sequences. A generated visual display may include a radial display with a dimension that is fixed and all sequences of entities of that dimension are used in generating the radial display, such as all conversion path sequences. Such a radial display may be used for visual searching and/or viewing the impact of certain entities, such as search terms, keywords, campaigns, etc. that lead to a desired action, such as a conversion action. The interactive system may include a radial sunburst diagram and a breadcrumb area that can selectively display drilldown information. The interface may be interacted with to display further information via selection of a conversion path prefix via mouseover (e.g., hover) and/or selecting an entity via mouse click.

### RELATED APPLICATION

This application claims foreign priority to Israeli Patent Application No. 233139, entitled, “DISPLAY GENERATION AND INTERACTIVE SYSTEM,” filed Jun. 15, 2014, the entirety of which is hereby incorporated by reference in its entirety.

### BACKGROUND

In a networked environment, such as the Internet or other networks, first-party content providers can provide information for public presentation on resources, such as webpages, documents, applications, and/or other resources. The first-party content can include text, video, and/or audio information provided by the first-party content providers via a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. The third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). Thus, a person viewing a resource can access the first-party content that is the subject of the resource as well as the third-party content that may or may not be related to the subject matter of the resource.

### SUMMARY

Implementations described herein relate to a visual display and interactive system for displaying data describing sequences and patterns which contain “entities” (e.g., search terms or keywords from web searches). An “entity” is an instance of a dimension that has a dimension/name pair that is associated with a particular path event. Dimensions may be a campaign, an advertisement group, a keyword, etc. Implementations of the system described herein uses raw text and log analysis data to generate a visual display that can be interacted with. Implementations of the generated visual display may include a radial display with a dimension that is fixed and all sequences of entities of that dimension are used in generating the radial display (e.g., all conversion paths). Such a radial display may be used for visual searching and/or viewing the impact of certain entities, such as search terms, keywords, campaigns, etc. that lead to a desired action, such as a conversion action. The interactive system for the visual display may include the radial diagram, such as a radial sunburst diagram, and a breadcrumb area that can selectively display drilldown information as the device interacts with the radial display. The interface may be interacted with to display further information via selection of a conversion path prefix via mouseover (e.g., hover) and/or selecting an entity via mouse click.

One implementation relates to a method for providing data related to conversion paths. The method includes receiving a dimension selection and determining a set of sequences responsive to the dimension selection. Each sequence of the set of sequences includes one or more entities associated with the dimension selection, and each of the one or more entities has a position in a respective sequence of the set of sequences. The method further includes generating a data structure for a sunburst diagram based on the determined set of sequences. The method still further includes transmitting the generated data structure and interface data for the sunburst diagram to a client device. The sunburst diagram includes a first arc and a second arc, where the first arc corresponds to a first node of the data structure and has a first arc length representative of a first aggregated number of one or more entities of the first node at a first position in a respective sequence of the set of sequences and the second arc corresponds to a second node of the data structure subsequent to the first node and has a second arc length representative of a second aggregated number of one or more entities of the second node at a second position in a respective sequence of the set of sequences. The interface data is configured to generate the sunburst diagram, to receive an interaction with the first arc or the second arc of the sunburst diagram, and to output data associated with the first aggregated number of one or more entities or the second aggregated number of one or more entities responsive to the interaction with the first arc or second arc.

Another implementation relates to a system for generating a visual display for an interface. The system may include one or more processors and one or more storage devices. The one or more storage devices include instructions that cause the one or more processors to perform several operations. The operations include receiving a dimension and a value selection and determining a set of sequences responsive to the dimension selection. Each sequence of the set of sequences includes one or more entities associated with the dimension selection, and each of the one or more entities has a position in a respective sequence of the set of sequences. The operations also include generating a data structure for a sunburst diagram based on the determined set of sequences and transmitting the generated data structure and interface data for the sunburst diagram to a client device. The sunburst diagram has a first arc and a second arc, where the first arc corresponds to a first node of the data structure and has a first arc length representative of a first aggregated number of one or more entities of the first node at a first position in a respective sequence of the set of sequences, and where the second arc corresponds to a second node of the data structure subsequent to the first node and has a second arc length representative of a second aggregated number of one or more entities of the second node at a second position in a respective sequence of the set of sequences. The interface data is configured to generate the sunburst diagram, to receive an interaction with the first arc or the second arc of the sunburst diagram, and to output value data based on the value selection associated with the first aggregated number of one or more entities or the second aggregated number of one or more entities responsive to the interaction with the first arc or second arc.

Yet a further implementation relates to a computer readable storage device storing instructions that, when executed by one or more processors, cause the one or more processors to perform several operations. The operations may include transmitting a dimension and a value selection to a performance analysis system. The operations also include receiving a generated trie data structure and interface data from the performance analysis system. The operations further include generating an interface including a sunburst diagram generated based on the trie data structure and the interface data. The sunburst diagram has a first arc and a second arc, where the first arc corresponds to a first node of the trie data structure and has a first arc length representative of a first aggregated number of one or more entities of the first node at a first position in a respective sequence of a set of sequences, and where the second arc corresponds to a second node of the trie data structure subsequent to the first node and has a second arc length representative of a second aggregated number of one or more entities of the second node at a second position in a respective sequence of the set of sequences. The operations still further include receiving an interaction with the first arc or the second arc of the sunburst diagram and outputting value data based on the value selection associated with the first aggregated number of one or more entities or the second aggregated number of one or more entities responsive to the interaction with the first arc or second arc.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an implementation of a system of providing information via a computer network;

FIG. 2 is a block diagram of a sequence having several entities;

FIG. 3 is a block diagram of two conversion paths each having several search term entities and ending in a conversion entity;

FIG. 4 is a diagram of an implementation of a trie data structure;

FIG. 5 is a block diagram of an implementation of a content item selection system having an analysis system for generating a data structure for a visual display and transmitting the data structure and interface data;

FIG. 6 is a process diagram of an implementation of a process for generating a data structure and interface data to generate a visual display at a client device and for outputting data responsive to interactions with an interface at the client device;

FIG. 7 is an overview of an implementation of a sunburst diagram visual display that may be generated using a generated data structure;

FIG. 8 is an overview of an implementation of an interface for displaying and interacting with a generated visual display;

FIG. 9 is a flow diagram of an implementation of a server-side process for generating and transmitting a data structure and interface data for generating a visual display;

FIG. 10 is a flow diagram of an implementation of a client device-side process for generating and interacting with a visual display; and

FIG. 11 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways as the described concepts are not limited to any particular manner of implementation. Specific implementations and applications are provided primarily for illustrative purposes.

A computing device (e.g., a client device) can view a resource, such as a webpage, a document, an application, etc. In some implementations, the computing device may access the resource via the Internet by communicating with a server, such as a webpage server, corresponding to that resource. The resource includes first-party content that is the subject of the resource from a first-party content provider and may also include additional third-party provided content, such as advertisements or other content. In one implementation, responsive to receiving a request to access a webpage, a webpage server and/or a client device can communicate with a data processing system, such as a content item selection system, to request a content item to be presented with the requested webpage, such as through the execution of code of the resource to request a third-party content item to be presented with the resource. The content item selection system can select a third-party content item and provide data to display the content item with the requested webpage on a display of the client device. In some instances, the content item is selected and served with a resource associated with a search query response. For instance, a search engine may return search results on a search results webpage and may include third-party content items related to the search query in one or more content item slots of the search results webpage.

The computing device (e.g., a client device) may also be used to view or execute an application, such as a mobile application. The application may include first-party content that is the subject of the application from a first-party content provider and may also include additional third-party provided content, such as advertisements or other content. In one implementation, responsive to use of the application, a resource server and/or a client device can communicate with a data processing system, such as a content item selection system, to request a content item to be presented with an interface of the application and/or otherwise. The content item selection system can select a third-party content item and provide data to display the content item with the application on a display of the client device.

In some instances, a device identifier may be associated with the client device. The device identifier may be a randomized number associated with the client device to identify the device during subsequent requests for resources and/or content items. In some instances, the device identifier may be configured to store and/or cause the client device to transmit information related to the client device to the content item selection system and/or resource server (e.g., values of sensor data, a web browser type, an operating system, historical resource requests, historical content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For instance, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For instance, a third-party content provider may place a bid in the auction that corresponds to an agreement to pay a certain amount of money if a client device interacts with the provider's content item (e.g., the provider agrees to pay $3 if a client device clicks on the provider's content item). In other implementations, a third-party content provider may place a bid in the auction that corresponds to an agreement to pay a certain amount of money if the content item is selected and served (e.g., the provider agrees to pay $0.005 each time a content item is selected and served). In some instances, the content item selection system uses content item interface data to determine the performance of the third-party content provider's content items.

Once a third-party content item is selected by the content item selection system, data to display the third-party content item on a display of the client device may be transmitted to the client device using a network.

The content item management service may include a performance analysis system used to analyze data regarding the context in which content items are served to client devices (e.g., the keywords of a webpage or search query that caused the content item to be selected and served), the sequence of various content items served to client devices, the sequence of campaigns of content items served to client devices, the sequence of different channels with which the content items were served to client devices (such as from e-mail, organic search results, paid search results, social network sites, direct browser interactions, etc.), etc. Such sequences may end with a conversion, which is a specified type of interaction that may be desired by a content provider, such as a purchase, a web page visit, a registration, etc. Prior to a conversion, any number of interactions with content items may occur. These interactions, along with the conversion, are a conversion path. Reports can be generated that provide an overview of where in time and/or where in position interactions occur in numerous conversion paths.

Such data regarding interactions and conversion paths from the performance analysis system may be used in a variety of ways. For instance, the sequences of keywords that lead to conversions may be used to generate visual displays for search terms and/or keywords that can indicate a numerical value and/or sequence that resulted in a conversion. In some instances, the data may be used to drilldown to analyze a specific sequence or sequences of search terms and/or keywords that resulted in a conversion. For instance, the drilldown ability may permit highlighting and saving of a selection (e.g., pinning) of specific sequence of search terms and/or keywords for later analysis or comparison to other specific sequences. In some instance, the visual display may permit adjusting of the direction of the sequences of search terms and/or keywords sequences to align from beginning-to-end or end-to-beginning. In some implementations, selected sequences may be highlighted and/or hidden from the generated visual display.

Accordingly, as described herein, a system may be provided for generating a visual display and interactive system for displaying data describing sequences and patterns which contain “entities” (e.g., search terms or keywords from web searches, interactions, etc.). An “entity” is an instance of a dimension that has a dimension/name pair that is associated with a particular path event. Dimensions may be a campaign, an advertisement group, a keyword, etc. Implementations of the system described herein may utilize raw text and log analysis data to generate a visual display that can be interacted with. Implementations of the generated visual display may include a radial display with a dimension that is fixed and all sequences of entities of that dimension are used in generating the radial display (e.g., all conversion paths for a campaign). Such a radial display may be used for visual searching and/or viewing the impact of certain entities, such as search terms, keywords, campaigns, etc., that lead to a desired action, such as a conversion. The interactive system for the visual display may include the radial diagram, such as a radial sunburst diagram, and a breadcrumb area that can selectively display drilldown information as a device interacts with the radial display. The interface may be interacted with to display further information via selection of a conversion path prefix via mouseover (e.g., hover) and/or selecting an entity via mouse click.

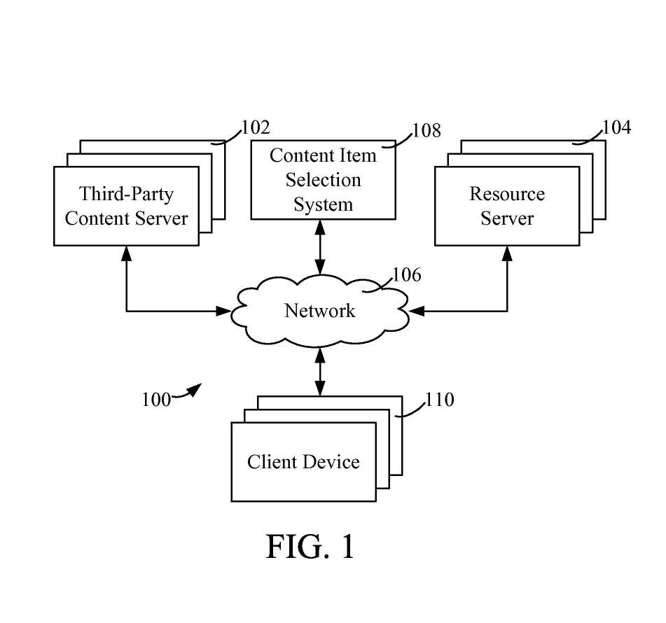

FIG. 1 is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system or processing module, such as a content item selection system 108. The content item selection system 108 can include at least one logic device, such as a computing device having a data processor, to communicate via the network 106, for instance with a resource server 104, a client device 110, and/or a third-party content server 102. The content item selection system 108 can include one or more data processors, such as a content placement processor, configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, Java®, ActionScript®, JavaScript®, JSON, Perl®, HTML, HTML5, XML, Python®, and Visual Basic®. The processing module may process instructions and provide data to display one or more content items to the resource server 104 and/or the client device 110. In addition to the processing circuit, the content item selection system 108 may include one or more databases configured to store data. The content item selection system 108 may also include an interface configured to receive data via the network 106 and to provide data from the content item selection system 108 to any of the other devices on the network 106. The content item selection system 108 can include a server, such as an advertisement server or otherwise.

The client device 110 can include one or more devices such as a computer, laptop, desktop, smart phone, tablet, personal digital assistant, set-top box for a television set, a smart television, or server device configured to communicate with other devices via the network 106. The device may be any form of portable electronic device that includes a data processor and a memory, i.e., a processing module. The memory may store machine instructions that, when executed by a processor, cause the processor to perform one or more of the operations described herein. The memory may also store data to display one or more resources, content items, etc. on the computing device. The processor may include a microprocessor, an application-specific integrated circuit (ASIC), a field-programmable gate array (FPGA), etc., or combinations thereof The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language.

The client device 110 can execute a software application (e.g., a web browser or other application) to retrieve content from other computing devices over network 106. Such an application may be configured to retrieve first-party content from a resource server 104. In some cases, an application running on the client device 110 may itself be first-party content (e.g., a game, a media player, etc.). In one implementation, the client device 110 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address (e.g., a resource server 104). The other device may then provide webpage data and/or other data to the client device 110, which causes visual indicia to be displayed by the display of the client device 110. Accordingly, the browser window displays the retrieved first-party content, such as webpages from various websites, to facilitate interaction with the first-party content.

The resource server 104 can include a computing device, such as a server, configured to host a resource, such as a webpage or other resource (e.g., articles, comment threads, music, video, graphics, search results, information feeds, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide resource data or other content (e.g., text documents, PDF files, and other forms of electronic documents) to the client device 110. In one implementation, the client device 110 can access the resource server 104 via the network 106 to request data to display a resource of the resource server 104.

One or more third-party content providers may have third-party content servers 102 to directly or indirectly provide data for third-party content items to the content item selection system 108 and/or to other computing devices via network 106. The content items may be in any format that may be presented on a display of a client device 110, for instance, graphical, text, image, audio, video, etc. The content items may also be a combination (hybrid) of the formats. The content items may be banner content items, interstitial content items, pop-up content items, rich media content items, hybrid content items, etc. The content items may also include embedded information such as hyperlinks, metadata, links, machine-executable instructions, annotations, etc. In some instances, the third-party content servers 102 may be integrated into the content item selection system 108 and/or the data for the third-party content items may be stored in a database of the content item selection system 108.

In one implementation, the content item selection system 108 can receive, via the network 106, a request for a content item to present with a resource. The received request may be received from a resource server 104, a client device 110, and/or any other computing device. The resource server 104 may be owned or ran by a first-party content provider that may include instructions for the content item selection system 108 to provide third-party content items with one or more resources of the first-party content provider on the resource server 104. In one implementation, the resource may include a webpage. The client device 110 may be a computing device operated by a user (represented by a device identifier), which, when accessing a resource of the resource server 104, can make a request to the content item selection system 108 for content items to be presented with the resource, for instance.

The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords of the content of the requested resource, text of the content of the resource, a title of the resource, a category of the resource, a type of the resource, a property of the resource, an interactivity level of the resource, a ranking of the resource, a popularity of the resource, a category of a publisher associated with the resource, a type of a publisher associated with the resource, a property of a publisher associated with the resource, etc.). The information or parameters that the content item selection system 108 receives can include a HyperText Transfer Protocol (HTTP) cookie which contains a device identifier (e.g., a random number) that represents the client device 110. In some implementations, the device and/or the resource information or parameters may be appended to a content item request URL (e.g., /page/contentitem?devid=abc123&devnfo=A34r0). In some implementations, the device and/or the resource information or parameters may be encoded prior to being appended to the content item request URL. The requesting device and/or the resource information or parameters may be utilized by the content item selection system 108 to select third-party content items to be served with the requested resource and presented on a display of a client device 110.

In some instances, a resource of a resource server 104 may include a search engine feature. The search engine feature may receive a search query (e.g., a string of text) via an input feature (an input text box, etc.). The search engine may search an index of documents (e.g., other resources, such as webpages, etc.) for relevant search results based on the search query. The search results may be transmitted as a second resource to present the relevant search results, such as a search result webpage, on a display of a client device 110. The search results may include webpage titles, hyperlinks, etc. One or more third-party content items may also be presented with the search results in a content item slot of the search result webpage. Accordingly, the resource server 104 and/or the client device 110 may request one or more content items from the content item selection system 108 to be presented in the content item slot of the search result webpage. The content item request may include additional information, such as the client device information, the resource information, a quantity of content items, a format for the content items, the search query string, keywords of the search query string, information related to the query (e.g., geographic location information and/or temporal information), etc. In some implementations, a delineation may be made between the search results and the third-party content items to avert confusion.

In some implementations, the third-party content provider may manage the selection and serving of content items by content item selection system 108. For instance, the third-party content provider may set bid values and/or selection criteria via an interface that may include one or more content item conditions or constraints regarding the serving of content items. A third-party content provider may specify that a content item and/or a set of content items should be selected and served for client devices 110 having device identifiers associated with a certain geographic location or region, a certain language, a certain operating system, a certain web browser, etc. In another implementation, the third-party content provider may specify that a content item or set of content items should be selected and served when the resource, such as a webpage, document, etc., contains content that matches or is related to certain keywords, phrases, etc. In a further implementation, the third-party content provider may specify that a content item or set of content items should be selected and served when a search query contains certain keywords, phrases, etc. The third-party content provider may set a single bid value for several content items, set bid values for subsets of content items, and/or set bid values for each content item. The third-party content provider may also set the types of bid values, such as bids based on whether a click on the third-party content item is performed, whether a specific action is performed based on the presentation of the third-party content item, whether the third-party content item is selected and served, and/or other types of bids.

In some implementations, the third-party content provider may desire feedback indicating how content items are performing, contextual information about conversions that occur as a result of a device being served one or more content items, and/or other performance information for the third-party content provider relative to one or more content items of the third-party content provider. In some implementations, such a performance and/or analysis system may be independent or separate from the content item selection system 108. In other implementations, the performance and/or analysis system may be a part of the content item selection system 108. That is, a content item management service provided by the content item selection system 108 may include a performance analysis system used to analyze data regarding the context in which content items are served to client devices 110 (e.g., the keywords of a webpage or search query that caused the content item to be selected and served), the sequence of various content items served to client devices 110, the sequence of campaigns of content items served to client devices 110, the sequence of different channels with which the content items were served to client devices 110 (such as from e-mail, organic search results, paid search results, social network sites, direct browser interactions, etc.), etc. Such sequences may end with a conversion, which is a specified type of interaction that may be desired by a content provider, such as a purchase, a web page visit, a registration, etc. Prior to a conversion, any number of interactions with content items may occur. These interactions, along with the conversion, are a conversion path. Reports can be generated that provide an overview of where in time and/or where in position interactions occur in numerous conversion paths.

Such data regarding interactions and conversion paths from the performance analysis system may be used in a variety of ways. For instance, the sequences of keywords that lead to conversions may be used to generate visual displays for search terms and/or keywords that can indicate a numerical value and/or sequence that resulted in a conversion. In some instances, the data may be used to drilldown to analyze a specific sequence or sequences of search terms and/or keywords that resulted in a conversion. The drilldown ability may permit highlighting and saving of a selection (e.g., pinning) of specific sequence of search terms and/or keywords for later analysis or comparison to other specific sequences. In some instance, the visual display may permit adjusting of the direction of the sequences of search terms and/or keywords sequences to align from beginning-to-end or end-to-beginning In some implementations, selected sequences may be highlighted and/or hidden from the generated visual display.

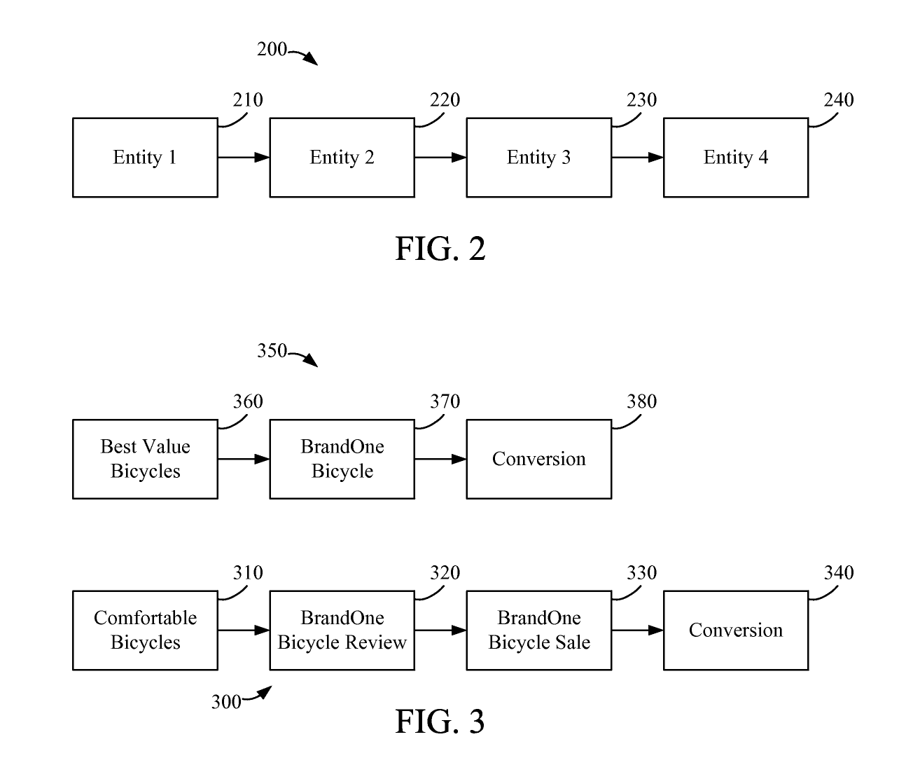

While the foregoing has provided an overview of a system 100 for selecting and serving content items to client devices 110 and/or for utilizing a performance analysis system to analyze performance of content items, FIG. 2 depicts a sequence 200, such as a conversion path, having several entities 210, 220, 230, 240 that may be utilized by the performance analysis system for providing information to a third-party content provider regarding the content items served by the content item selection system 108. The sequence 200 may be any sequential set of one or more entities 210, 220, 230, 240. In some implementations, the entities 210, 220, 230, 240 may be representative of discrete interactions with a particular client device, such as client device 110, represented by a device identifier. The entities 210, 220, 230, 240 may each include information regarding the discrete interaction with the particular client device, such as a one associated with a device identifier for the client device, a type of interaction (e.g., whether a content item was served, whether the content item was selected or clicked on, whether a conversion occurred, etc.), a context for the interaction (e.g., a medium through which the content item was served, selection criteria for the selected content item, a resource with which the content item was served, etc.), etc.

In some implementations, the sequence 200 may end with a conversion entity. That is, a content provider of the content item may specify an action that is a goal of the content provider, such as a purchase, a registration, a donation, etc. The content provider may include, as part of a web page of the content provider, embedded instructions that can transmit data indicative of when a conversion occurs. For instance, a script, such as a JavaScript®, may execute when a client device requests a final landing page, such as a confirmation page for a purchase, a registration, a donation, etc. The execution of the script may transmit data indicative of the device identifier for the client device and other information associated with the conversion, such as a total purchase amount, etc.

The sequence, such as sequence 200, of entities leading up to the conversion is a conversion path. Analysis of conversion paths can indicate to content providers the various content items served to a client device leading up to the conversion, the search or query terms used that resulted in the content items served to a client device leading up to the conversion, resources with which the content items were served to a client device leading up to the conversion, etc. Such conversion paths may be useful to content providers to allocate more or less of a budget to one or more content items, remove ineffective content items, optimize resources with which content items are served, add, modify, or remove selection criteria for content items, etc.

In some instances, a conversion may be attributed to a keyword or search term used as a serving criterion when a content item that is served based on the keyword or search term is the last clicked content item prior to the conversion. A content provider may associate the keywords “tennis,” “shoes,” and “Brand-X” with one or more content items of a campaign for Brand-X tennis shoes. Assuming that a query is submitted from a client device for a first search query of “tennis,” a content item selection system, such as content item selection system 108, may select and serve to the client device the content provider's content item based on the selection criterion of “tennis” to be presented with a search result page. A client device may select or click on the served content item, but may not perform an action that constitutes a conversion, such as a purchase. If a subsequent second search query is submitted from a client device for “Brand-X,” the content item selection system may again select and serve to the client device the content provider's content item based on the selection criterion of “Brand-X” to be presented with a search result page. If, in this instance, the client device selects or clicks on the content item and performs an action that constitutes a conversion (e.g., purchases Brand-X tennis shoes), then the sequence of the first entity of searching for “tennis,” subsequently searching for “Brand-X,” and ending in a conversion of a purchase of Brand-X tennis shoes is considered a conversion path. In some implementations, the keyword or search term “Brand-X” may be credited with the conversion because the last content item selected prior to the conversion was presented responsive to the keyword or search term of “Brand-X” selection criterion. In other implementations, credit may be apportioned to both “tennis” and “Brand-X.”

In some implementations, it may be useful to a content provider to analyze their aggregated conversion path sequences. For instance, such aggregated conversion path sequences may indicate to a content provider which search or query terms assist or lead to conversions. That is, the aggregated sequencing of related and/or unrelated search or query terms may be searched for prior to a conversion. If the search or query terms are those which the content provider is not using as selection criteria, the content provider may decide to include such search or query terms as selection criteria when modifying a content item campaign, creating a new campaign, etc.

For instance, a set of two sequences 300, 350 are shown for two different conversion paths having various entities 310, 320, 330, 340, 360, 370, 380. A first sequence or conversion path 300 includes a sequence of searches 310, 320, 330 using search queries “Comfortable Bicycles,” “BrandOne Bicycle Review,” and “BrandOne Bicycle Sale” that lead to a conversion 340. A second sequence or conversion path 350 includes a sequence of searches 360, 370 using search queries “Best Value Bicycles” and “BrandOne Bicycle” that lead to a conversion 380. As shown in FIG. 3, varying search queries submitted by a client device may ultimately lead to a conversion 340, 380 for a BrandOne bicycle. If, for instance, the search terms “BrandOne Bicycle” and “Bicycle” are used as selection criteria for a content item associated with the BrandOne Bicycle, then the content item may be a candidate for selection and serving to a client device that submits a search including one or those search terms. The search term “Bicycles” is a broad selection criterion, which may, in some instance, result in many candidate content items from different content providers being candidates for selection and serving. Accordingly, the content item from the content provider for the BrandOne bicycle may be selected less often and/or may cost more when selected based on the increased competition. If a performance analysis system aggregates conversion path sequences and, for instance, the search terms “best value bicycle” and “comfortable bicycles” result in conversions more often, the content provider may decide to focus the selection criteria on such terms or reallocate a portion of a budget for bidding on such narrower search terms than the broader “bicycle” search term. In other implementations, unrelated search terms may be discovered that were not known or used by the content provider, but which, in the aggregate, were used as search terms that resulted in conversions for the BrandOne bicycle.

The sequence of entities, such as search terms in a conversion path, may be presented in a raw datalog form or a tabular form listing all sequences. However, if the data is generally large in size, it may be difficult to recognize patterns from the sequences of entities. Thus, it may be preferable to provide an easier form for presenting the sequences of entities. In some implementations, this may simply be an aggregated totaling of the occurrences of search terms in the aggregated sequences. In some implementations, it may be preferable to provide a visual display of the aggregated sequences of entities such that a content provider may easily comprehend and recognize patterns from the aggregated sequence of entities. In addition, it may be useful to provide interactivity to such a visual display via an interface that permits selection of various portions of the visual display as well as the ability to drilldown into the underlying data from which the visual display is derived.

Such a visual display and interface may be useful to allow a content provider have the search terms or keywords visually displayed that depicts the relative numerical value of various aggregated entities and/or sequences that lead to or resulted in a conversion action, to interact with the visual display and/or underlying data to analyze specific sequences of search terms or keywords that lead to or resulted in a conversion action, to highlight and/or save a selection (e.g., via pinning) of a specific sequence of search terms or keywords, to compare a saved selection of a specific sequence of search terms or keywords amongst multiple selected sequences, to adjust the direction of the search terms or keywords sequences to align from beginning-to-end or end-to-beginning of a sequence of search query terms (e.g., first-clicked/displayed content items or last-clicked or displayed content items), to adjust the data or mathematical model used by the visual display system that defines the displaying and formatting of the visual display, to highlight and/or hide sequences and/or patterns (e.g., continuous repeating search terms or sequences) to enhance the ease of use of the visual display and/or interface, and/or to display and highlight certain sequences using a logical mechanism with a defined attribute, such as limiting the displayed search or query terms to a predetermined number of distinct search or query terms or limiting the displayed sequences to those that match, exceed, and/or are below a predetermined number of occurrences in the aggregated conversion path sequences (i.e., only showing conversion path sequences that, when aggregated, make up at least 5% of the total aggregated conversion path sequences).

In some implementations, conversion path sequences may have varying lengths and/or may have different entities at various positions, but share common search or query terms at the same position. For instance, a conversion path sequence may include entities for search terms of “Comfortable Bicycles,” “BrandOne Bicycle Review,” and “BrandOne Bicycle Sale.” Another conversion path sequence may also include the entity for the search term “Comfortable Bicycles,” but may include the search terms “BrandOne Bicycle Store” prior to the conversion in the conversion path sequence. Thus, the two conversion path sequences share the common initial search term of “Comfortable Bicycles” at a first position of the conversion path sequence, then split for the subsequent search terms in each respective conversion path sequence.

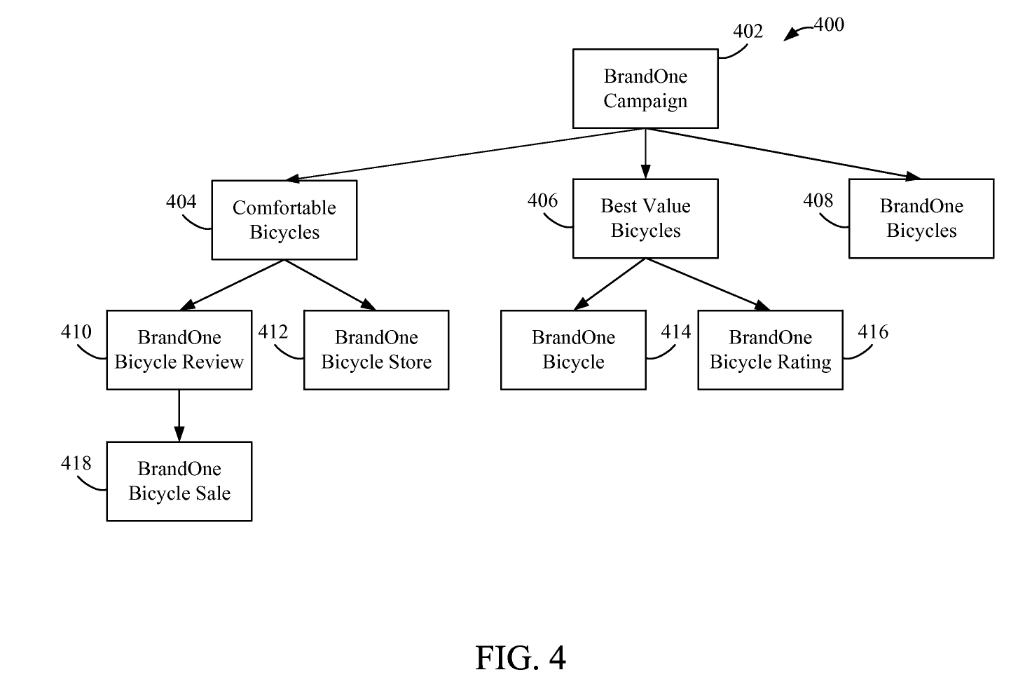

In some implementations, the aggregation of conversion path sequences may utilize a trie data structure, such as the representation 400 of a trie data structure of FIG. 4, to aggregate the conversion path sequences having common entities at the same position while also indicating the other, unshared entities. The representation 400 of an instance of a trie data structure for a BrandOne campaign is depicted in FIG. 4. A root node 402 for the BrandOne campaign is the beginning of the representation 400 of the trie data structure. The conversion path sequences can be aggregated to determine nodes 404, 406, 08, 410, 412, 414, 416, 418 for the trie data structure for the root node 402 of the BrandOne campaign.

For instance, a set of five conversion path sequences may be aggregated to form the trie representation 400 of FIG. 4. A first conversion path sequence may include entities for search terms of “Comfortable Bicycles,” “BrandOne Bicycle Review,” and “BrandOne Bicycle Sale.” A second conversion path sequence may also include the entity for the search term “Comfortable Bicycles,” but may include the search terms “BrandOne Bicycle Store” prior to the conversion in the conversion path sequence. A third conversion path sequence may include entities for search terms of “Best Value Bicycles” and “BrandOne Bicycle.” A fourth conversion path sequence may also include the entity for the search term “Best Value Bicycles,” but may include the search terms “BrandOne Bicycle Rating” prior to the conversion in the conversion path sequence. A fifth conversion path sequence may include a single entity for the search terms “BrandOne Bicycles.” The set of five conversion paths may be aggregated into a trie data structure such that the first and second conversion path sequences share the node 404 for the search terms “Comfortable Bicycles” and the third and fourth conversion path sequences share the node 406 for the search terms “Best Value Bicycles.” The nodes 404, 406 may include data indicative of the number of conversion path sequences that have been aggregated into each respective node 404, 406, such as numerical value of 2 for nodes 404, 406. That is, the value at a given trie node is the total value of all conversion path sequences in the trie data structure that begin with the unique sequence of entities defined by the path from the root node to the node in question. Thus, when a node of the trie data structure is selected, data for the node having the value may be retrieved to determine the number of conversion path sequences that contain the unique sequence leading to that node. Of course any number of conversion path sequences may be aggregated into a trie data structure such that hundreds, thousands, millions, billions, etc. of nodes may be generated for the trie data structure.

The trie data structure generated for the aggregated conversion path sequences may be used in the generation of visual display, such as sunburst diagram, as will be described in greater detail herein.

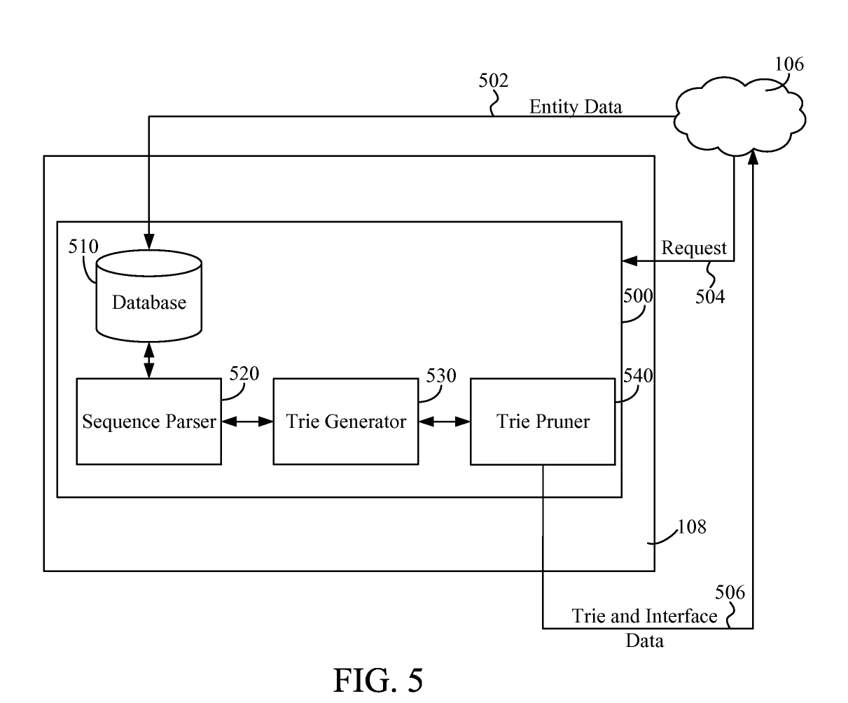

FIG. 5 depicts an implementation of a performance analysis system 500 of a content item selection system 108 that may be utilized to generate a trie data structure, such as the representation 400 shown in FIG. 4, and may transmit the generated data structure and interface data 504 to a device, such as a client device, to display a visual display based on the data of the data structure and the interface data and for interaction with the visual display. In some implementations, the performance analysis system 500 may be part of the content item selection system 108 or the performance analysis system 500 may be separate from the content item selection system 108 (e.g., a separate performance analysis system that may analyze the performance of content items served via several content item selection systems).

The performance analysis system 500 receives entity data for an entity 502 via the network 106. The entity data may include data regarding a discrete interaction with a particular client device, such as a one associated with a device identifier for the client device, a type of interaction (e.g., whether a content item was served, whether the content item was selected or clicked on, whether a conversion occurred, etc.), a context for the interaction (e.g., a medium through which the content item was served, selection criteria for the selected content item, a resource with which the content item was served, etc.), etc. The received entity data may include a conversion entity responsive to a client device performing an action constituting a conversion. The content provider of a content item may specify an action that is a goal of the content provider, such as a purchase, a registration, a donation, etc. to be a conversion action.

The received entity data may be stored in a database 510 of the performance analysis system 500. The entity data may be stored in the database 510 as a flat table, a log file, etc. The entity data stored in the database 510 may include data referencing a corresponding content item or campaign, a device identifier which received the content item, and data representing conditions under which the content item was selected and served to a client device. In some implementations each entity may be stored with similar entities (e.g., with other entities from the same device identifier) as path sequences and/or each entity may be stored individually. In some instances, each entity may be stored individually and, responsive to receiving a conversion entity, entities associated with the same device identifier as the conversion entity may be combined to form a conversion path sequence and stored together. The performance analysis system 500 may utilized a predetermined look-back window to include only those entities that occurred within the predetermined look-back window as part of the conversion path sequence. That is, the performance analysis system may not include entities having an associated timestamp that occurs earlier in time than the predetermined look-back window. This may eliminate older entities that may not have impacted the conversion event (e.g., a content item shown 6 months ago may be unlikely to affect a conversion).

The performance analysis system 500 may receive a request 504 for trie data and interface data from a device, such as a client device, for the performance of a content item, campaign, and/or a combination thereof. The request 504 includes a dimension (e.g., a keyword search term, content item, content item group, and/or campaign) that will be used to retrieve a relevant subset of conversion path sequences from the database 510 responsive to the selected dimension. That is, a device ay send a request 504 to the performance analysis system 500 that indicates what scope of the stored conversion path sequences and entities are to be analyzed and presented in a visual display. The request 504 may also include a date range (e.g., last 6 months, last 90 days, last 30 days, last 15 days, last two weeks, last 7 days, etc.) and/or a value metric (e.g., a conversion number or conversion monetary value for the aggregated conversion path sequences).

The performance analysis system 500 includes a sequence parser 520 that queries the database 510 for entities and/or conversion path sequences responsive to the selected dimension of the received request 504. The sequence parser 520 retrieves the entity data and/or conversion path sequences and parses sequence into a set of entities for each conversion path sequence. In some implementations, the sequence parser 520 may retrieve a predetermined number of conversion path sequences, such as the 20,000 most recent conversion path sequences based on a timestamp of the conversion entity, or a predetermine percentage of the total conversion paths, such as 90%, 95%, 99%, etc.

The performance analysis system 500 includes a trie generator 530 for generating one or more trie data structures. In some implementations, other data structures may be used, such as other tree-type data structures. The trie generator 530 generates an initial trie data structure based on the aggregate conversion path sequences and parsed entities from the sequence parser 520. The trie generator 530 generates nodes for the generated trie. Each generated node stores data indicative of the corresponding entity (e.g., a string identifying the search or query terms, a medium for the entity, etc.) and a value for the node as fields for the node. The value at a given trie node is the total value (e.g., number or aggregate monetary value based on the value metric) of all conversion path sequences in the trie data structure that begin with the unique sequence of entities defined by the path from the root node to the node in question. The node may also include a map storing the node's child nodes, which may be keyed by the child node's entity. In some instances, the trie generator 530 may generate the trie data as the sequence parser 520 parses conversion path sequences into entities. In some implementations the trie generator 530 may include a predetermined maximum path length, such as a heightLimit parameter, such that entities in a conversion path sequence that exceed the maximum path length are truncated from the generated trie data structure. The trie generator 530 may also determine a total value (e.g., number or aggregate monetary value based on the value metric) of all the trie paths that contain a given entity occurring at least once in the trie data structure. That is, the trie generator 530 may determine a total number of instances of each entity, regardless of position in the trie data structure such that a set of top n entities may be determined based on the total value, where n may be a predetermined value, a variable parameter, and/or a received parameter with the request 504. Thus, the total values trie generator 530 may be utilized to determine, for instance, a top 10, a top 8, a top 6, a top 4, etc. entities based on the number of occurrences in the conversion path sequences.

The performance analysis system 500 may further includes a trie pruner 540. The trie pruner 540 may be configured to prune the trie data structure generated by the trie generator 530 to eliminate and/or aggregate nodes of the trie data structure that are below or exceed a threshold, such as a predetermined threshold, a variable threshold, and/or a received threshold parameter with the request 504. For instance, the trie pruner 540 may determine the top n entities based on the total values determined by the trie generator 530. The trie pruner 540 may determine a top N conversion path sequences for a first level of the trie data structure based on the top n entities (i.e., a set of N sequences starting with one of the top n entities). The trie pruner 540 may then aggregate the remaining first level nodes of the trie data structure together into an aggregate first level node (e.g., an “Other” node) for the trie data structure where the trie node does not exceed a threshold or is not in the top N conversion path sequences. The threshold may be entities may be a predetermined value, a variable parameter, and/or a received parameter with the request 504. In some implementations, the threshold may be a percentage, such as 1%, 2%, 5%, 10%, etc. If the aggregated node is below the threshold, the trie pruner 540 may remove the aggregated node from the trie data structure. The trie pruner 540 may continue through the subsequent levels of the trie data structure aggregating and/or eliminating nodes from the trie data structure. In some implementations, metadata regarding one or more nodes aggregated into the aggregated node may be included as data with the aggregated node, such as a list of the top 10 nodes by number or percentage of conversion path sequences. Thus, additional information for the underlying nodes aggregated into the aggregate node may be presented using such data.

In an implementation, if the top n entities is a top 10, then the top N sequences for the trie data structure will be those sequences that begin with an entity included with the top 10 entities. The nodes of the trie data structure that are not in the top 10 entities will be aggregated into an aggregated node (e.g., “Other”). If the aggregated node and/or a top N sequence is below the threshold, it may be removed from the trie data structure. The child nodes for the remaining first level nodes that are included in the top 10 entities may then be determined and the child nodes that are not in the top 10 entities will be aggregated into a second level aggregated node (e.g., “Other”). If the second level aggregated node and/or a child node associated with an entity in the top 10 entities is below the threshold, it may be removed from the trie data structure. Such a pruning process may continue through the entirety of the trie data structure or until a maximum path length is exceeded such that entities in a conversion path sequence that exceed the maximum path length are truncated/pruned from the trie data structure.

The trie data and interface data may be transmitted 506 responsive to the request 504. The trie data may include the pruned trie data structure and a list of node metadata for each node in the trie. The node metadata may include an entity name for the corresponding node of the trie data structure or, for aggregated nodes, the list of the top entities that were aggregated into the aggregated node.

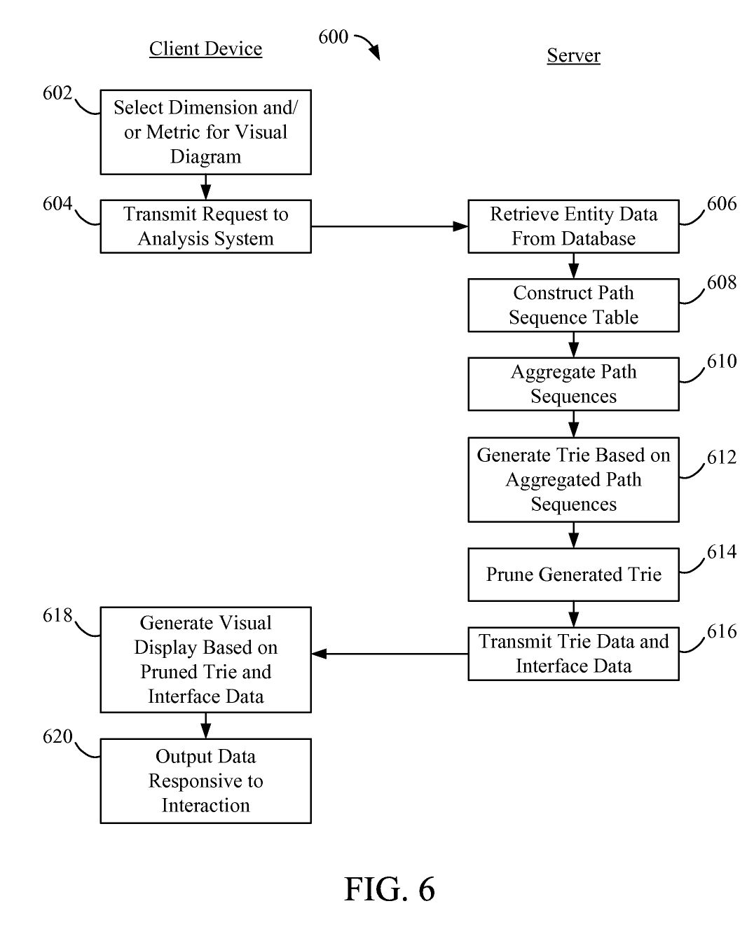

FIG. 6 depicts an implementation of a process 600 for generating a visual display for a client device and an interface for interacting with the visual display and the underlying data. The process includes receiving a dimension selection for the visual diagram at a client device (block 602). The dimension may be a keyword search term, content item, content item group, a campaign, etc. That is, a content provider may select the dimension parameter such that conversion path segments for a particular content item, a particular campaign, a particular search term, etc. are selected. A date range (e.g., last 6 months, last 90 days, last 30 days, last 15 days, last two weeks, last 7 days, etc.) and/or a value metric (e.g., a conversion number or conversion monetary value for the aggregated conversion path sequences) may also be selected via the client device. A request for a data structure, such as a trie data structure, to generate a visual display and interface data for an interface us transmitted to an analysis system (block 604). The request includes the selected dimension parameter, date range, and/or value metric.

Entity data and/or conversion path sequence data is retrieved from the database (block 606) responsive to the request. The entity data and/or conversion path sequence data may be retrieved using the sequence parser 520 that queries the database 510 for entities and/or conversion path sequences responsive to the selected dimension of the received request. A conversion path sequence table is constructed (block 608) based on the retrieved entity data and/or conversion path sequence data. In some implementations, the construction of a conversion path sequence table may be performed offline or prior to receiving a request from the client device. The conversion path sequences from the constructed conversion path sequence table are aggregated (block 610). That is, identical conversion path sequences may be aggregated together and a total value for the aggregated conversion path sequences may be included in the data.

A trie data structure is generated based on the aggregated conversion path sequences (block 612). The trie data structure may be generated by the trie generator 530 by generating nodes for the generated trie, where each generated node stores data indicative of the corresponding entity (e.g., a string identifying the search or query terms, a medium for the entity, etc.) and a value for the node as fields for the node. The value at a given trie node is the total value (e.g., number or aggregate monetary value based on the value metric) of all conversion path sequences in the trie data structure that begin with the unique sequence of entities defined by the path from the root node to the node in question. The node may also include a map storing the node's child nodes, which may be keyed by the child node's entity.

The generated trie data structure is pruned (block 614) to aggregate and/or remove nodes from the generated trie data structure. The pruning of the trie data structure may be performed by the trie pruner 540 to eliminate and/or aggregate nodes of the trie data structure that are below or exceed a threshold, such as a predetermined threshold, a variable threshold, and/or a received threshold parameter as described herein. Trie data and interface data are transmitted to the client device responsive to the request (block 616). The trie data may include the trie data structure and a list of node metadata for each node in the trie. The node metadata may include an entity name for the corresponding node of the trie data structure or, for aggregated nodes, the list of the top entities that were aggregated into the aggregated node. The interface data includes data for generating an interface for displaying and interacting with the visual display based on the trie data. The interface data may include a script, such as a JavaScript®, for rendering a sun burst diagram based on the trie data and for presenting data associated with the trie data with the interface, as will be described in greater detail herein.

The client device receives the trie data and interface data and generates a visual display, such as a sunburst diagram, based on the trie data and an interface based on the interface data (block 618) for presentation on a display of the client device. The interface may receive one or more interactions with the visual display and/or interface and the interface data may cause the client device to output data responsive to the interaction (block 620), such as displaying a tooltip responsive to a mouseover or hover over a portion of the visual display, displaying one or more selected sequences of entities responsive to a mouse click on a portion of the visual display, etc.

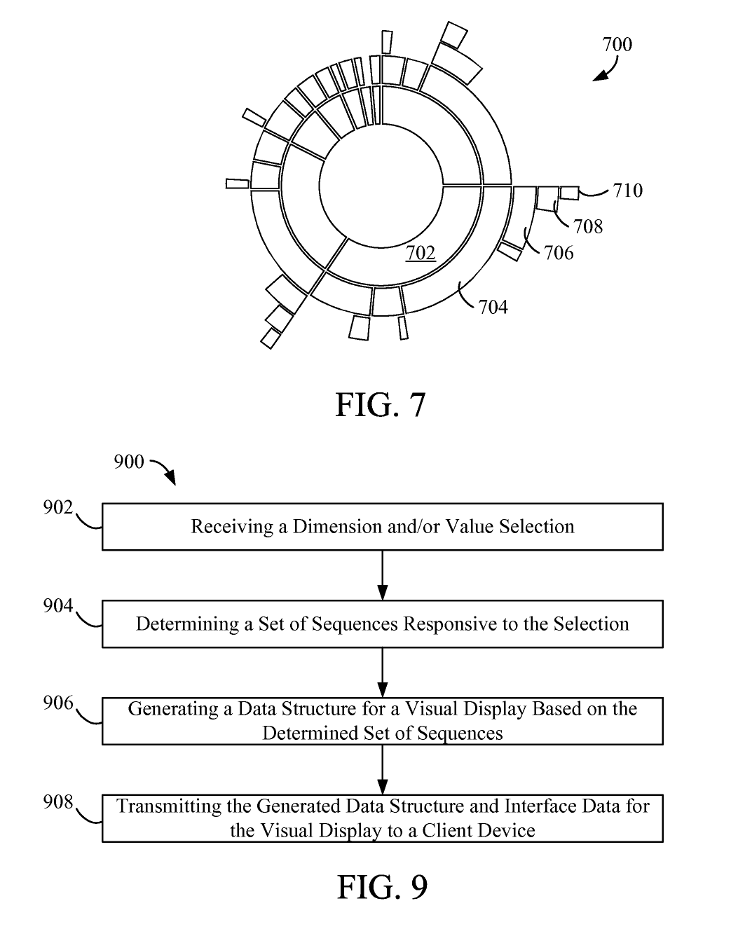

FIG. 7 depicts an implementation of a visual display 700 that may be generated based on the trie data. The visual display 700 is a sunburst diagram includes several arcuate members 702, 704, 706, 708, 710 representative of nodes of the trie data structure. The sunburst diagram includes several interior arcs 702, intermediate arcs 704, 706, 708, and several outer arcs 710. Each interior arc 702 corresponds to a first node of the data structure and has an arc length representative of a first aggregated number of entities of the first node at a first position in a respective conversion path sequence. Similarly, the intermediate arcs 704, 706, 708 correspond to intermediate nodes subsequent to the first node of the data structure and have arc lengths representative of the aggregated number of entities of the corresponding intermediate node at a corresponding position in a respective conversion path sequence. An outer arc 710 corresponds to a lowest node of the data structure for a particular sequence and has an arc length representative of an aggregated number of one or more entities of the lowest node of the data structure for a particular sequence.

That is, the inner arcs in the inner layer correspond to the entities that appear as the first step in a conversion path sequence of the data structure. The next set of arcs in the next layer each corresponds to entities that appear as the second step in a respective conversion path sequence of the data structure, etc. Thus, a first arc may be representative of a first entity occurring in a respective sequence before a second entity represented by a second arc exterior to the first arc. Therefore the sunburst diagram 700 is a visualization of a prefix trie encoding a collection of conversion path sequences. Each arc is nested within an arc on a previous layer (with the exception of the first arcs), and each arc thus uniquely corresponds to a conversion path segment (a sequence of entities of a conversion path sequence) that is defined by entities for the corresponding nodes of the data structure from the inner layer to the given arc. The arc length of the arc is proportional to the aggregate total of all conversion path sequences that begin with the corresponding path segment (where value is either conversion count or conversion revenue) relative to the total of all conversion path sequences.

In some implementations, the arcs and the sunburst diagram may be reversed, with the outer arcs corresponding to the entities that appear as the first step in a conversion path sequence of the data structure. The next set of arcs in the next interior layer each corresponds to entities that appear as the second step in a respective conversion path sequence of the data structure, etc. Thus, a first arc may be representative of a first entity occurring in a respective sequence after a second entity represented by a second arc interior to the first arc.

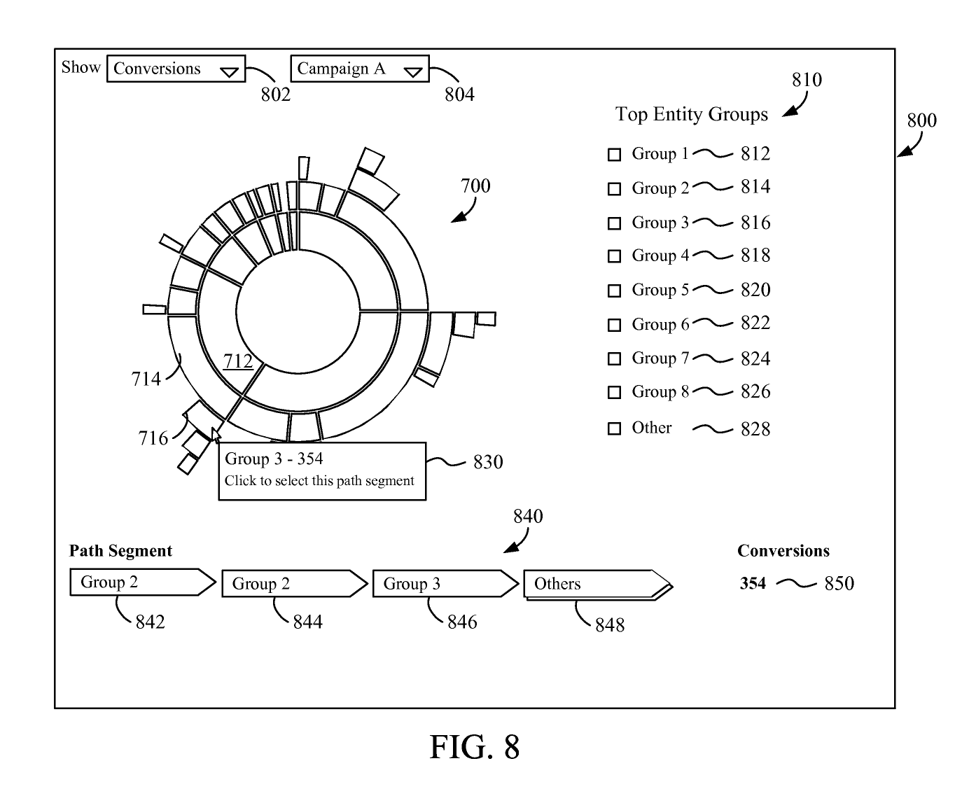

FIG. 8 shows an interface 800 for displaying a generated visual display, such as the sunburst diagram 700 of FIG. 7, and for interacting with the visual display and/or the underlying data structure. The interface 800 includes a selection feature 802 for selecting a value metric for a request. The selection feature 802 is a dropdown box for selecting a value metric from a list of value metrics (e.g., a conversion number or conversion monetary value for the aggregated conversion path sequences). In other implementations, the selection feature 802 may include radio buttons, text entry boxes, etc. The interface 800 also includes a selection feature 804 for selecting a dimension for the request. The selection feature 804 is a dropdown box for selecting a dimension from a list of dimensions (e.g., a keyword search term, content item, content item group, and/or campaign). In other implementations, the selection feature 804 may include radio buttons, text entry boxes, etc. In some implementations, a further selection feature (not shown) may be included for selecting or defining a date range, such as a dropdown box, a calendar feature, radio buttons, a text entry box, etc. In some implementations, an update button or other feature may be used to transmit the request once selections are made. In other implementations, the request may be transmitted responsive to a dimension selection. The visual display and/or the data displayed may update responsive to changes to the value metric (e.g., toggling between a conversion total amount and a monetary value).

The interface 800 includes a list 810 of the top distinct entities 812, 814, 816, 818, 820, 822, 824, 826 and aggregated entities 828. The interface 800 also displays the visual display, such as sunburst diagram 700 in a portion of the interface responsive to receiving the tie data or data structure and the interface data. In some implementations, the interface data may include a color scheme for displaying the different top distinct entities 812, 814, 816, 818, 820, 822, 824, 826 and aggregated entities 828 of the visual display in different colors. For instance, the arcs in the sunburst diagram 700 may be given colors through an ordered list of CSS color classes based on matching the list 810 of distinct entities 812, 814, 816, 818, 820, 822, 824, 826 and aggregated entities 828 in the visual display with a CSS class from the list of color classes. Every arc corresponding to a distinct entity 812, 814, 816, 818, 820, 822, 824, 826 or an aggregated entity 828 is given the assigned color. In some implementations, the aggregated entities are colored gray. The number of colors and the specific order of colors for the CSS color classes may be predetermined and/or defined via the interface 800.

In some implementations, when the visual display is first generated, a direction indicator may be displayed to indicate the direction of the conversion path sequences (e.g., an arrow pointing outward indicating the inner arcs correspond to first entities in the conversion path sequences or an arrow pointing inward indicating the outer arcs correspond to first entities in the conversion path sequences). The indicator may fade after a predetermined period of time.

Each arc in the sunburst diagram 700 defines a unique path segment that begins (or in last-click implementations, ends) one or more conversion paths as defined by the data structure. To determine the sequence of entities for the unique path segment, the entities interior (or in some instances, exterior) of a given arc can be stepped along to identify the unique path segment. For instance, for arc 716, the unique path corresponds to conversion paths beginning with the sequence of entities represented by arc 712, arc 714, and including arc 716.

The interface data is configured to generate visual displays, display or output data, and/or otherwise permit interaction with the underlying data of the data structure used to generate the visual display, such as a sunburst diagram 700. For instance, the interface data may be configured to output the data associated with an aggregated number of entities represented by an arc of the visual display as a tooltip responsive to a mouseover interaction. For instance, a mouseover arc 716 displays the name of the entity represented by the arc 716 as “Group 3” entities and the value for the unique conversion path segment represented by arc 717, such as 354 conversions begin with the unique segment of the entities represented by arcs 712, 714, 716. In some instances, the entities may be search or query terms. Hovering over an arc may also highlight the corresponding path segment on the visual display, such as by highlighting arcs 712, 714, 716 when hovering over arc 716. If the arc corresponds to an aggregated entity, the displayed tooltip may also shows the top entities (e.g., top 3, top 5, etc.) that were aggregated into the node represented by the arc as well as the number of other aggregated entities.

The interface data may be further configured to display the data associated with the aggregated number of entities in a path list portion 840 of the interface 800 responsive to a click interaction with an arc of the visual display. For instance, if a click selection is performed on arc 716, the path list portion 840 may be populated with the selected unique path segment of arcs 712, 714, 716 as representations of a sequence of entities 842, 844, 846 associated with the unique path segment of arcs 712, 714, 716 responsive to the click interaction. Subsequent entities to the selected unique path segment may be aggregated and displayed as a representation 848 of the aggregated subsequent entities. The path list portion 840 may also display, responsive to the click selection, a value 850 defined by the value metric, such as the total number or monetary value, of all conversions path sequences in the visual display that begin with the selected unique path segment. Multiple unique path segments may be selected and added to the path list portion 840 such that comparisons of the unique path segments and/or the values may be done. In some implementations, the interface data may be further configured to highlight the arcs, such as arcs 712, 714, 716, in the visual display responsive to mousingover or hovering over an entry of the unique path segment displayed in the path list portion 840. Unique path segments may be saved (i.e., the data from the data structure may be written to a file) and/or may be removed from the path list portion 840.

In some implementations, long entity names may be truncated in the list 810 of the top distinct entities and/or path list portion 840. In further implementations, the selection of an arc may display an animation, such as having the arcs move from the visual display to the path list portion 840 and transform into the representations of the corresponding entities. In further implementations, a selection of a distinct entity 812, 814, 816, 818, 820, 822, 824, 826 or an aggregated entity 828 from the list 810 may highlight all instances of the selected distinct entity in the visual display. In some further implementations, the values displayed may be displayed as a percentage of the total value for the visual display (e.g., the percentage of total conversions or percentage of total aggregated monetary value). The interface 800 may further include a feature to toggle between a first-click display and a last-click display. In yet further implementations, several visual displays may be generated and displayed for differing date ranges such that data for two different time ranges (which may or may not overlap) may be analyzed and/or compared.

FIG. 9 is flow diagram of an implementation of a server-side process 900 for generating and transmitting a data structure and interface data for generating a visual display, such as a sunburst diagram, and an interface for interacting with the visual display. The process 900 includes receiving a dimension and/or value selection (block 902). The dimension selection and/or a value metric selection may be received from a device, such as a client device, via a network, such as network 106. The selection may be performed at the client device using an interface feature, such as selection features 802, 804 of FIG. 8. The received dimension and/or value metric selections may be received with a request for a data structure for generating a visual display. In some implementations, a date range or other time period selection may be received with the dimension and/or value metric selections.

A set of sequences is determined responsive to the selection (block 904). The set of sequences may be determined based on entity data and/or conversion path sequence data retrieved from a database that matches the selected dimension. That is, a sequence parser may query a database for entities and/or conversion path sequences that correspond to the selected dimension, such as all entities and/or conversion path sequences for a selected content item, content item group, campaign, etc. In some implementations, a conversion path sequence table may be constructed based on the retrieved entity data and/or conversion path sequence data. The construction of a conversion path sequence table may be performed offline or prior to receiving a request from the client device. The conversion path sequences from the constructed conversion path sequence table are aggregated such that identical conversion path sequences may be aggregated together and a total value for the aggregated conversion path sequences may be included in the data.

The process 900 further includes generating a data structure for a visual display based on the determined set of sequences (block 906). The data structure may be a trie data structure. In some implementations, the generation of the data structure may include generating a trie data structure based on the determined set of sequences, with each node of the trie data structure representative of an aggregated number of entities having a same position in a respective sequence of the determined set of sequences. The generated data structure may be a data structure constructed from the entire determined set of sequences of the data structure may be pruned to remove and/or aggregate sequences and/or nodes. The generation of the data structure may include pruning a trie data structure based on a predetermined number of unique entities and/or based on a predetermined percentage of a total of the set of sequences. That is, a trie generator may be configured to eliminate and/or aggregate nodes of the trie data structure that are below or exceed a threshold, such as a predetermined threshold, a variable threshold, and/or a received threshold parameter. For instance, the trie pruner may determine the top n entities based on the total values of each entity in the determined set of sequences. The trie pruner may determine a top N conversion path sequences for a first level of the trie data structure based on the top n entities (i.e., a set of N sequences starting with one of the top n entities). The trie pruner may then aggregate the remaining first level nodes of the trie data structure together into an aggregate first level node (e.g., an “Other” node) for the trie data structure where the trie node does not exceed a threshold or is not in the top N conversion path sequences. The threshold may be entities may be a predetermined value, a variable parameter, and/or a received parameter. In some implementations, the threshold may be a percentage, such as 1%, 2%, 5%, 10%, etc. If the aggregated node is below the threshold, the trie pruner may remove the aggregated node from the trie data structure. The trie pruner may continue through the subsequent levels of the trie data structure aggregating and/or removing nodes from the trie data structure. In some implementations, metadata regarding one or more nodes aggregated into the aggregated node may be included as data with the aggregated node, such as a list of the top 10, top5, top 3, etc. nodes by number or percentage of conversion path sequences. Thus, additional information for the underlying nodes aggregated into the aggregate node may be presented using such data.

The process 900 may further include transmitting the generated data structure and interface data for the visual display to a client device (908). The data structure, such as a trie data structure, may be included in trie data and may be transmitted with interface data responsive to a request from the client device. The trie data may include the pruned trie data structure and a list of node metadata for each node in the trie. The node metadata may include an entity name for the corresponding node of the trie data structure or, for aggregated nodes, the list of the top entities that were aggregated into the aggregated node.

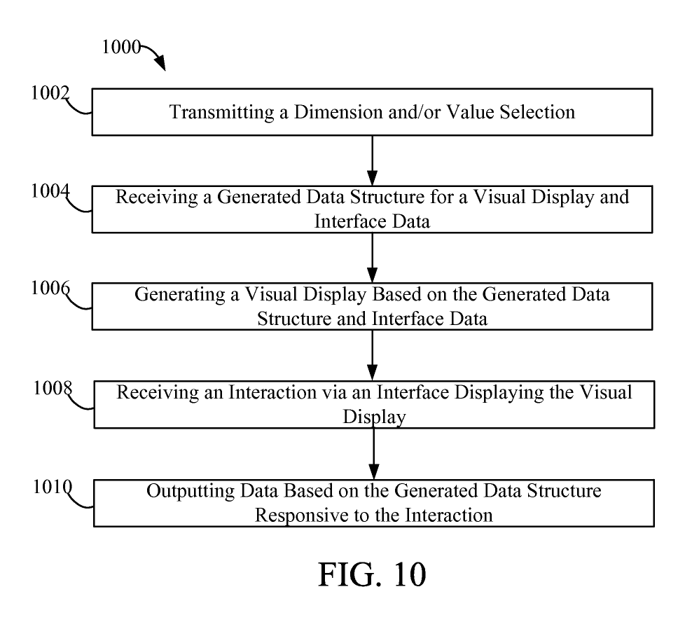

FIG. 10 is a flow diagram of an implementation of a client device-side process 1000 for generating and interacting with a visual display. The process includes transmitting a dimension and/or value metric selection (block 1002). The dimension selection and/or a value metric selection may be transmitted to a server hosting a performance analysis system, such as a content item selection system 108, via a network, such as network 106. The selection may be performed using an interface feature, such as selection features 802, 804 of FIG. 8. The transmitted dimension and/or value metric selections may be transmitted with a request for a data structure for generating a visual display, such as a sunburst diagram. In some implementations, a date range or other time period selection may be transmitted with the dimension and/or value metric selections.

The process 1000 further includes receiving a generated data structure for a visual display and interface data (block 1004). The generated data structure may be a trie data structure and, in some implementations, may be a pruned trie data structure. The received trie data structure may be included with trie data, which may include meta data regarding the trie data structure. The interface data may be a script, such as a JavaScript®, that is configured to generate a sunburst diagram based on the trie data and to generate an interface for interaction with the sunburst diagram and the underlying data of the received data structure.

The process 1000 further includes generating a visual display based on the generated data structure and the interface data (block 1006). The visual display may be a sunburst diagram that includes several arcuate members that are representative of nodes of the generated data structure. The sunburst diagram may include several interior arcs, intermediate arcs, and outer arcs. Each interior arc corresponds to a first node of the data structure and has an arc length representative of a first aggregated number of entities of the first node at a first position in a respective conversion path sequence. Similarly, the intermediate arcs correspond to intermediate nodes subsequent to the first node of the data structure and have arc lengths representative of the aggregated number of entities of the corresponding intermediate node at a corresponding position in a respective conversion path sequence. Each outer arc corresponds to a lowest node of the data structure for a particular sequence and has an arc length representative of an aggregated number of one or more entities of the lowest node of the data structure for a particular sequence.

That is, the inner arcs in the inner layer correspond to the entities that appear as the first step in a conversion path sequence of the data structure. The next set of arcs in the next layer each corresponds to entities that appear as the second step in a respective conversion path sequence of the data structure, etc. Thus, a first arc may be representative of a first entity occurring in a respective sequence before a second entity represented by a second arc exterior to the first arc. Therefore the sunburst diagram visual display is a visualization of a prefix trie encoding a collection of conversion path sequences. Each arc is nested within an arc on a previous layer (with the exception of the first arcs), and each arc thus uniquely corresponds to a conversion path segment (a sequence of entities of a conversion path sequence) that is defined by entities for the corresponding nodes of the data structure from the inner layer to the given arc. The arc length of the arc is proportional to the aggregate total of all conversion path sequences that begin with the corresponding path segment (where value is either conversion count or conversion revenue) relative to the total of all conversion path sequences.

In some implementations, the arcs and the sunburst diagram may be reversed, with the outer arcs corresponding to the entities that appear as the first step in a conversion path sequence of the data structure. The next set of arcs in the next interior layer each corresponds to entities that appear as the second step in a respective conversion path sequence of the data structure, etc. Thus, a first arc may be representative of a first entity occurring in a respective sequence after a second entity represented by a second arc interior to the first arc. The generation of the visual display may be generated as part of an interface, such as interface 800 of FIG. 8. The interface data is configured to generate the features of the interface and to generate visual displays and/or output data for display.

The process 1000 further includes receiving an interaction via an interface displaying the generated visual display (block 1008). The received interaction may include a mouseover or hover interaction, a click interaction, etc. Data is output based on the generated data structure responsive to the interaction (block 1010). In some implementations, the interface data may be configured to output data associated with an aggregated number of entities represented by an arc of the visual display as a tooltip responsive to a mouseover interaction. For instance, a mouseover of a particular arc may display the name of the entity represented by the arc and the value for the unique conversion path segment, such as a number of conversions beginning with the unique segment of the entities and/or a monetary value. In some instances, the entities may be search or query terms. Hovering over an arc may also highlight the corresponding path segment on the visual display. If the arc corresponds to an aggregated entity, the displayed tooltip may also shows the top entities (e.g., top 3, top 5, etc.) that were aggregated into the node represented by the arc as well as the total number of aggregated entities.

The interface data may be further configured to display data associated with an aggregated number of entities in a path list portion of the interface responsive to a click interaction with an arc of the visual display. For instance, if a click interaction is received regarding a particular arc, then the path list portion of the interface may be populated with the selected unique path segment of arcs as representations of a sequence of entities associated with the unique path segment of the arcs responsive to the click interaction. Subsequent entities to the selected unique path segment represented by the clicked on arc may be aggregated and displayed as a representation of the aggregated subsequent entities. The path list portion may also display, responsive to the click selection, a value defined by the value metric, such as the total number or monetary value, of all conversions path sequences in the visual display that begin with the selected unique path segment. Multiple unique path segments may be selected and added to the path list portion such that comparisons of the unique path segments and/or the values may be done. In some implementations, the interface data may be further configured to highlight the arcs in the visual display responsive to mousingover or hovering over an entry of the unique path segment displayed in the path list portion 840. Unique path segments may be saved (i.e., the data from the data structure may be written to a file) and/or may be removed from the path list portion.

In some implementations, the selection of an arc may display an animation, such as having the arcs move from the visual display to the path list portion and transform into the representations of the corresponding entities. In further implementations, a selection of a distinct entity or an aggregated entity from a list of top entities may highlight all instances of the selected distinct entity in the visual display and/or may display the total number of instances of the selected entity in all of the determined set of sequences. In some further implementations, the values displayed may be displayed as a percentage of the total value for the visual display (e.g., the percentage of total conversions or percentage of total aggregated monetary value). The interface may further include a feature to toggle between a first-click display and a last-click display. In yet further implementations, several visual displays may be generated and displayed for differing date ranges such that data for two different time ranges (which may or may not overlap) may be analyzed and/or compared.

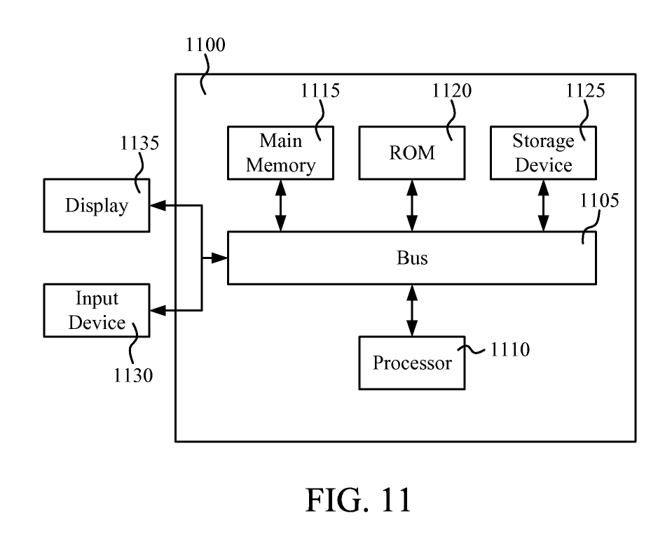

FIG. 11 is a block diagram of a computer system 1100 that can be used to implement the client device 110, content item selection system 108, third-party content server 102, resource server 104, etc. The computing system 1100 includes a bus 1105 or other communication component for communicating information and a processor 1110 or processing module coupled to the bus 1105 for processing information. The computing system 1100 can also include one or more processors 1110 or processing modules coupled to the bus for processing information. The computing system 1100 also includes main memory 1115, such as a RAM or other dynamic storage device, coupled to the bus 1105 for storing information, and instructions to be executed by the processor 1110. Main memory 1115 can also be used for storing position information, temporary variables, or other intermediate information during execution of instructions by the processor 1110. The computing system 1100 may further include a ROM 1120 or other static storage device coupled to the bus 1105 for storing static information and instructions for the processor 1110. A storage device 1125, such as a solid state device, magnetic disk or optical disk, is coupled to the bus 1105 for persistently storing information and instructions. Computing device 1100 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 1100 may be coupled via the bus 1105 to a display 1135, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information. An input device 1130, such as a keyboard including alphanumeric and other keys, may be coupled to the bus 1105 for communicating information and command selections to the processor 1110. In another implementation, the input device 1130 may be integrated with the display 1135, such as in a touch screen display. The input device 1130 can include a cursor control, such as a mouse, a trackball, or cursor direction keys, for communicating direction information and command selections to the processor 1110 and for controlling cursor movement on the display 1135.

According to various implementations, the processes and/or methods described herein can be implemented by the computing system 1100 in response to the processor 1110 executing an arrangement of instructions contained in main memory 1115. Such instructions can be read into main memory 1115 from another computer-readable medium, such as the storage device 1125. Execution of the arrangement of instructions contained in main memory 1115 causes the computing system 1100 to perform the illustrative processes and/or method steps described herein. One or more processors in a multi-processing arrangement may also be employed to execute the instructions contained in main memory 1115. In alternative implementations, hard-wired circuitry may be used in place of or in combination with software instructions to effect illustrative implementations. Thus, implementations are not limited to any specific combination of hardware circuitry and software.

Although an implementation of a computing system 1100 has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” “processing circuit,” or “processing module” encompass all kinds of apparatus, devices, and machines for processing data, including a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, for instance, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including semiconductor memory devices, e.g., EPROM, EEPROM, and flash memory devices; magnetic disks, e.g., internal hard disks or removable disks; magneto optical disks; and CD ROM and DVD disks. The processor and the memory can be supplemented by, or incorporated in, special purpose logic circuitry.

To provide for interaction, implementations of the subject matter described in this specification can be implemented on a computer having a display device, e.g., a CRT (cathode ray tube) or LCD monitor, for displaying information and a keyboard and a pointing device, e.g., a mouse or a trackball, by which input can be provided to the computer. Other kinds of devices can be used to provide for interaction as well; for instance, feedback can be provided via any form of sensory feedback, e.g., visual feedback, auditory feedback, or tactile feedback; and input can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A method for providing data related to conversion paths comprising:
receiving, by one or more data processors, a dimension selection;
determining, using one or more data processors, a plurality of sequences responsive to the dimension selection, each of the plurality of sequences comprising one or more entities associated with the dimension selection, each of the one or more entities having a position in a respective sequence of the plurality of sequences;
generating, using one or more data processors, a data structure for a sunburst diagram based on the determined plurality of sequences; and
transmitting, by one or more data processors, the generated data structure and interface data for the sunburst diagram to a client device, the sunburst diagram having a first arc and a second arc, the first arc corresponding to a first node of the data structure and having a first arc length representative of a first aggregated number of one or more entities of the first node at a first position in a respective sequence of the plurality of sequences, the second arc corresponding to a second node of the data structure subsequent to the first node and having a second arc length representative of a second aggregated number of one or more entities of the second node at a second position in a respective sequence of the plurality of sequences;
the interface data configured to generate the sunburst diagram, to receive an interaction with the first arc or the second arc of the sunburst diagram, and to output data associated with the first aggregated number of one or more entities or the second aggregated number of one or more entities responsive to the interaction with the first arc or second arc.

2. The method of claim 1 wherein the data structure is a trie data structure, wherein generating the data structure for the sunburst diagram comprises generating, using one or more data processors, the trie data structure based on the determined plurality of sequences, each node of the trie data structure representative of an aggregated number of one or more entities having a same position in a respective sequence of the plurality of sequences.

3. The method of claim 2, wherein generating the data structure for the sunburst diagram further comprises pruning the trie data structure based on a predetermined number of unique entities.

4. The method of claim 2, wherein generating the data structure for the sunburst diagram further comprises pruning the trie data structure based on a predetermined percentage of a total of the plurality of sequences.

5. The method of claim 1, wherein the interface data is configured to output the data associated with the first aggregated number of one or more entities or the second aggregated number of one or more entities as a tooltip responsive to a mouseover interaction with the first arc or second arc.

6. The method of claim 1, wherein the interface data is configured to display the data associated with the first aggregated number of one or more entities or the second aggregated number of one or more entities in a portion of an interface of a client device responsive to a click interaction with the first arc or second arc.

7. The method of claim 6, wherein the interface data is further configured to display a sequence of entities associated with the first arc or second arc in the portion of the interface of the client device responsive to the click interaction.

8. The method of claim 1, wherein the interface data is further configured to highlight one or more arcs of the sunburst diagram responsive to a selection of the first arc or second arc.

9. The method of claim 1, wherein the first arc is representative of a first entity occurring in a respective sequence before a second entity represented by the second arc.

10. The method of claim 1, wherein the first arc is representative of a first entity occurring in a respective sequence after a second entity represented by the second arc.

11. A system for generating a visual display for an interface comprising:
one or more data processors; and one or more storage devices storing instructions that, when executed by the one or more data processors, cause the one or more data processors to perform operations comprising:
receiving a dimension and a value selection;
determining a plurality of sequences responsive to the dimension selection, each of the plurality of sequences comprising one or more entities associated with the dimension selection, each of the one or more entities having a position in a respective sequence of the plurality of sequences;
generating a data structure for a sunburst diagram based on the determined plurality of sequences; and
transmitting the generated data structure and interface data for the sunburst diagram to a client device, the sunburst diagram having a first arc and a second arc, the first arc corresponding to a first node of the data structure and having a first arc length representative of a first aggregated number of one or more entities of the first node at a first position in a respective sequence of the plurality of sequences, the second arc corresponding to a second node of the data structure subsequent to the first node and having a second arc length representative of a second aggregated number of one or more entities of the second node at a second position in a respective sequence of the plurality of sequences;
the interface data configured to generate the sunburst diagram, to receive an interaction with the first arc or the second arc of the sunburst diagram, and to output value data based on the value selection associated with the first aggregated number of one or more entities or the second aggregated number of one or more entities responsive to the interaction with the first arc or second arc.

12. The system of claim 11, wherein the data structure is a trie data structure, wherein generating the data structure for the sunburst diagram comprises generating, using one or more data processors, the trie data structure based on the determined plurality of sequences, each node of the trie data structure representative of an aggregated number of one or more entities having a same position in a respective sequence of the plurality of sequences.

13. The system of claim 12, wherein generating the data structure for the sunburst diagram further comprises pruning the trie data structure.

14. The system of claim 13, wherein pruning the trie data structure comprises:
removing a node from the trie data structure responsive to a respective aggregated number of the node not exceeding a predetermined percentage of a total of the plurality of sequences.

15. The system of claim 13, wherein pruning the trie data structure comprises:
determining a set of top entities based on a predetermined number of unique entities; and
aggregating into an aggregated node one or more nodes of the data structure that are not associated with an entity of the determined set of top entities.

16. A computer readable storage device storing instructions that, when executed by one or more data processors, cause the one or more data processors to perform operations comprising:
transmitting a dimension and a value selection to a performance analysis system;
receiving a generated trie data structure and interface data from the performance analysis system;
generating an interface including a sunburst diagram generated based on the trie data structure and the interface data, the sunburst diagram having a first arc and a second arc, the first arc corresponding to a first node of the trie data structure and having a first arc length representative of a first aggregated number of one or more entities of the first node at a first position in a respective sequence of a plurality of sequences, the second arc corresponding to a second node of the trie data structure subsequent to the first node and having a second arc length representative of a second aggregated number of one or more entities of the second node at a second position in a respective sequence of the plurality of sequences;
receiving an interaction with the first arc or the second arc of the sunburst diagram; and
outputting value data based on the value selection associated with the first aggregated number of one or more entities or the second aggregated number of one or more entities responsive to the interaction with the first arc or second arc.

17. The computer readable storage device of claim 16, wherein the value data comprises an aggregate number of one or more entities for the first arc or second arc.

18. The computer readable storage device of claim 16, wherein the value data comprises an aggregated monetary value for the first arc or the second arc.

19. The computer readable storage device of claim 16 further comprising:
displaying one or more representations representative one or more entities responsive to the interaction with the first arc or second arc.

20. The computer readable storage device of claim 16, wherein the plurality of sequences are conversion path sequences.
